(19) United States
(12) Patent Application Publication
(10) Pub. No.: US 2007/0150104 A1
(43) Pub. Date: Jun. 28, 2007

(54) Apparatus and method for controlling network-based robot

(76) Inventors: Choul Soo Jang, Daejeon-city (KR); Myung Chan Roh, Daejeon-city (KR); Seung Woog Jung, Daejeon-city (KR); Sung Hoon Kim, Daejeon-city (KR); Joong Bae Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/636,044

(22) Filed: Dec. 8, 2006

(30) Foreign Application Priority Data
Dec. 8, 2005 (KR) 10-2005-0119471
May 10, 2006 (KR) 10-2006-0042012

(51) Int. Cl. G06F 19/00

(52) U.S. Cl. 700/245

(57) ABSTRACT

An apparatus and method of controlling a network-based robot are provided. The apparatus includes a first connection unit connecting to at least one application component server or content server through a network, a second connection unit connecting to a wireless internet sharing router to communicate with the robot, and a middleware receiving and storing an application component from the application component server, executing the application component to generate an operational command for the robot, sending the generated operational command to the robot, and processing information which is sent by the robot. The apparatus and method provide a quick response to sensor information from the robot without incurring a burden of connecting to various service servers and managing the connections on the robot. In addition, a size of an internal buffer of the robot is minimized to enable the robot to respond to neighbor environments in real time.

### CROSS-REFERENCE TO RELATED PATENT APPLICATION

This application claims the benefits of Korean Patent Application No. 10-2005-0119471, filed on Dec. 8, 2005, and Korean Patent Application No. 10-2006-0042012, filed on May 10, 2006, in the Korean Intellectual Property Office, the disclosures of which are incorporated herein in their entirety by reference.

### BACKGROUND OF THE INVENTION

1. Field of the Invention

The present invention relates to an apparatus and method for controlling a low-priced robot through a network.

2. Description of Related Art

The present invention relates to an apparatus and method for controlling a low-priced robot through a network.

Generally, since independent-type robots include internal high-capacity storage devices, the robots can independently perform information recognition, information processing, and actions. However, due to the widespread use of network technology, network-based robots have emerged. In a network-based robot, a high-capacity storage device and an information processing function are not included, and only basic sensing and networking functions are included. In a network-based robot, functions that are performed independently by a robot are distributed over networks, so that a remote server can perform the functions that are usually performed by the robot. Both high-priced and low-priced network-based robots are available. High-priced robots generally perform basic codes internally such as behavior and tasks to perform basic decisions and corresponding operations, and only parts of the functions of the robot which require knowledge and reasoning of a high level are performed by a high-performance server connected to a network. On the other hand, in low priced robots, all decisions are made by a server, and the robot is designed to be operated by downloading operational information from the server according to the decisions.

In other words, the network-based robot of the low-priced type sends all information acquired from sensors and a microphone to a server. Then, the server makes a decision based on the information acquired from the sensors and the microphone, generates operational information according to the decision as a continuous series of operational packets, and transfers the operational packets to the robot. Here, the operational packets include information on operations that last only for tens of milliseconds, and the operational packets are transferred continuously to the robot. The robot that receives the operational packets from the server repeatedly interprets the operational packets and operates for a time directed in the packets. Since the robot of the low-priced type includes a central processing unit (CPU) having a limited performance and a minimal memory, the robot cannot be loaded with a heavy protocol stack such as a transmission control protocol (TCP). Accordingly, a user datagram protocol (UDP) is used for transferring the packets between the robot and the server. Since the UDP has a lower reliability, packet loss, delayed delivery, or out-of-order packets may occur.

In server systems for a network-based robot 110 of the low-priced type, two kinds of configurations can be used. In the first configuration, a control server 130 connected to the robot 110 though the Internet 120 is assigned to each application service, as illustrated in FIG. 1, and a remote control server corresponding to a required application service is connected. In the second configuration, the robot 210 is connected only to a proxy control server 220 which performs a proxy function, as illustrated in FIG. 2. In the first configuration of assigning a server to each application, as illustrated in FIG. 1, when a new application other than a currently operating application is required to be performed, the robot should be disconnected from the currently operating control server and connected to a control server which executes the new application, and should send the sensor and microphone information to the newly connected server to receive the operational packets. Therefore, the robot has a burden of managing server connection for each application.

In the second configuration illustrated in FIG. 2 of using a control server which performs a proxy function, since the sensor information which is sent by the robot should be transferred to a content server 230 through a control server 220 to be processed, the response time increases, which makes it difficult for the robot to respond in real time.

In both configurations illustrated in FIGS. 1 and 2, since the robot should communicate with a remote control server, delivery delay and non-uniform arrival time of the operational packets for the robot may occur due to instability of communication between the robot and the remote control server, which means that the operation of the robot may not be performed smoothly and may pause intermittently. In order to solve a problem due to the instability of communication between the robot and the remote control server, a method in which information including directions for operations to be transferred from the content server 330 to the robot 310 is downloaded prior to performing the operations and stored in a buffer, as illustrated in FIG. 3, as operational packets corresponding to several seconds of operations, and the operational packets are read and corresponding operations are performed one by one has been proposed. However, when operational packets corresponding to several seconds of operations are downloaded into and stored in the robot, the control server should wait for several seconds until all the operational packets stored in the internal buffer of the robot are executed, which makes it difficult for the robot to respond immediately to a change in a situation even when the control server receives the sensor information from the robot and tries to cope with the sudden change in the situation. Therefore, in this case, an additional mechanism for controlling the internal buffer of the robot is required.

In other words, in a method used for configuring the robot, the control server generates a buffer control packet having a form different from that of the operational packet stored in the internal buffer of the robot and sends the buffer control packet to the robot, the robot receiving the buffer control packet does not store the buffer control packet in the internal buffer and performs an operation of vacating the internal buffer immediately after the buffer control packet is received, and next arriving operational packets are newly stored in the internal buffer. However, in this method, delivery of the buffer control packet may be delayed, so that a buffer control command sent from the server may not be reflected immediately. In addition, the buffer control packet may be lost, so that the buffer control command sent from the server may not be reflected at all. In addition to the disadvantages due to delay and loss of the buffer control packet, since an additional operation of the server for controlling the buffer of the robot is required, development of an application service becomes complicated. In addition, since the robot should be designed to identify the operational packets and buffer control packets, the structure of the robot becomes complicated.

### SUMMARY OF THE INVENTION

The present invention provides an apparatus and method of controlling a network-based robot capable of providing various services without a burden of connecting to servers and managing the connections on the robot of a low-priced type and providing a quick responsiveness of a server for sensor information from the robot to enable the robot to respond to neighbor environments in real time without a problem in that the operation of the robot is not performed smoothly and is paused intermittently according to delivery delay and non-uniform arrival time of packets due to instability of communication between the robot and the remote control server.

According to an aspect of the present invention, there is provided an apparatus for controlling a network-based robot, the apparatus comprising: a first connection unit connecting to at least one application component server or content server through a network; a second connection unit connecting to a wireless internet sharing router to communicate with the robot; and middleware receiving and storing an application component from the application component server, executing the application component to generate an operational command for the robot, sending the generated operational command to the robot, and processing information which is sent by the robot.

According to another aspect of the present invention, there is provided a method of controlling a network-based robot using a robot control server which controls the robot by connecting to at least one robot, application storage server, or content server, the method comprising: (a) requesting an application component needed by the robot to the application storage server and receiving and storing the application component; (b) generating events for each type based on sensor information which is transferred from the robot and generating an operational packet including information on an operation of the robot according to the type of the event; and (c) sending the operational packet to the robot in response to the request of the robot.

According to another aspect of the present invention, there is provided a method of controlling a network-based robot, the method comprising: (a) preparing a communication thread which communicates with a robot control server, an operational thread which operates the robot, and a packet holder which connects the communication and operational threads; (b) storing an operational packet and sending a request packet for a next operation to the robot control server when the packet holder is vacant; (c) requesting an application component to an application storage server, and receiving and storing the application component by the robot control server that receives the request packet; (d) generating events for each type based on sensor information which is transmitted by the robot and generating an operational packet including operational information on the robot for each type of the event; (e) sending the operational packet to the robot in response to the request of the robot; and (f) receiving the operational packet, checking whether the packet holder is vacant, storing the received operational packet when the packet holder is vacant, and waiting until the packet holder becomes vacant when the packet holder is not vacant.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a method of controlling-a network-based robot in which a server is configured for each service using a technology in the related art;

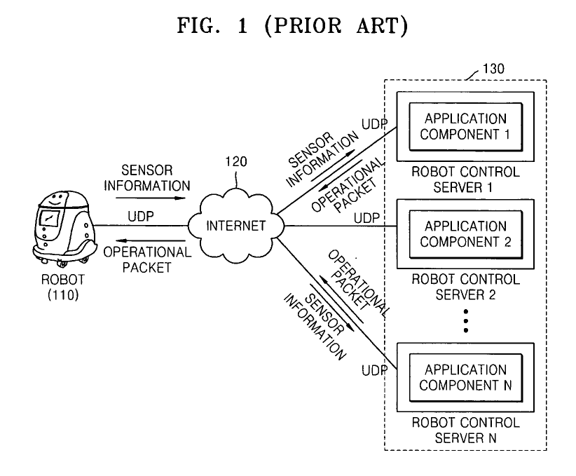

FIG. 2 is a diagram illustrating a method of controlling a network-based robot using a proxy server, according to a technology in the related art;

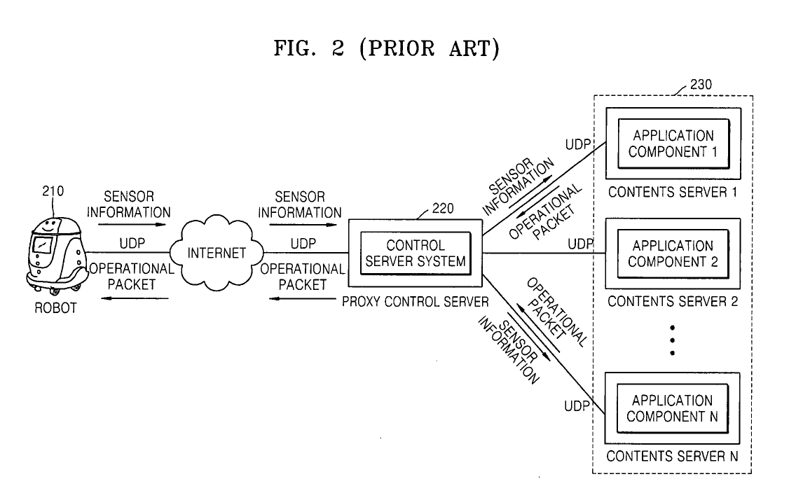

FIG. 3 is a diagram illustrating a method of using a buffer inside a robot, using a technology in the related art;

FIG. 4 is a diagram illustrating an example of configuring a server system for controlling a network-based robot of a low-priced type, according to an embodiment of the present invention;

FIG. 5 is a block diagram illustrating an apparatus for controlling a network-based robot according to an embodiment of the present invention;

FIG. 6 is a flowchart illustrating a method of controlling a network-based robot according to an embodiment of the present invention;

FIG. 7 illustrates a class diagram for a robot application component loaded in a robot control middleware according to an embodiment of the present invention;

FIG. 8 is a diagram illustrating a method in which an internal buffer of a robot is not used according to an embodiment of the present invention; and

FIG. 9 is a block diagram illustrating a flow of packet processing inside a robot according to an embodiment of the present invention.

### DETAILED DESCRIPTION OF THE INVENTION

Now, exemplary embodiments of the present invention will be described in detail with reference to the accompanying drawings.

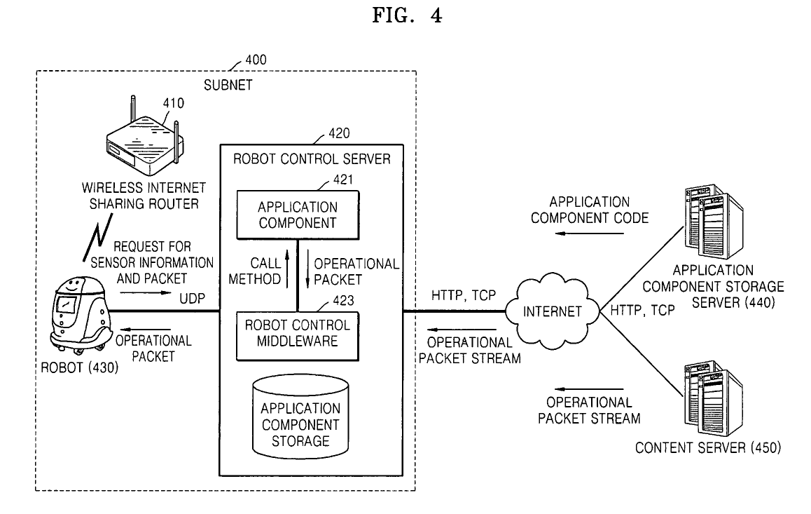

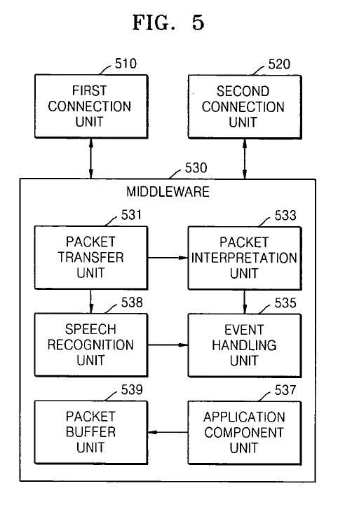

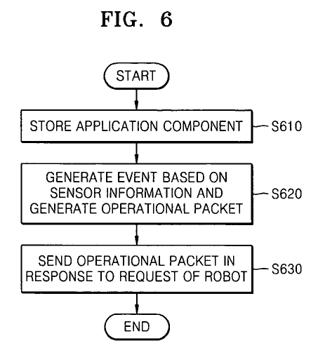

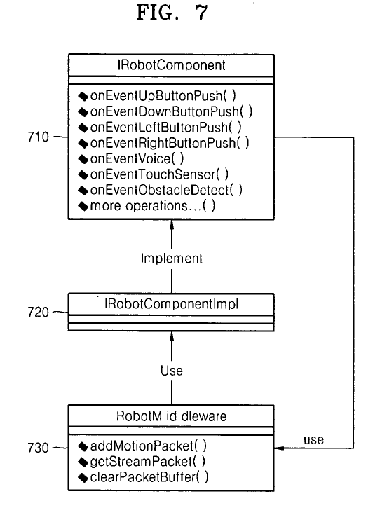

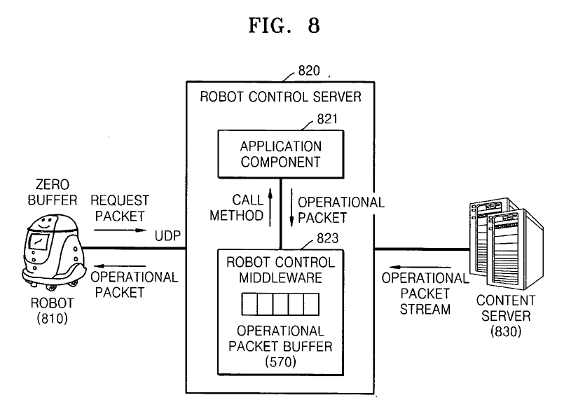

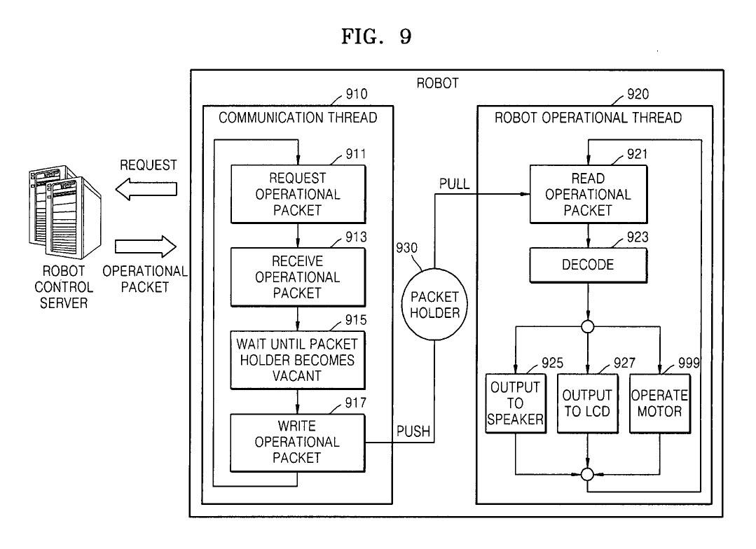

FIG. 4 is a diagram illustrating an example of configuring a server system for controlling a network-based robot of a low-priced variety, according to an embodiment of the present invention. FIG. 5 is a block diagram illustrating an apparatus for controlling a network-based robot, according to an embodiment of the present invention. FIG. 6 is a flowchart illustrating a method of controlling a network-based robot according to an embodiment of the present invention. FIG. 7 illustrates a class diagram for a robot application component loaded in a robot control middleware, according to an embodiment of the present invention. FIG. 8 is a diagram illustrating a method in which an internal buffer of a robot is not used, according to an embodiment of the present invention. FIG. 9 is a block diagram illustrating a flow of packet processing inside a robot according to an embodiment of the present invention.

Operational links between an apparatus for controlling a network-based robot according to an embodiment of the present invention and a robot or various servers will now be described with reference to FIG. 4.

In the low-priced type robot 430 which is controlled through a network, a wireless LAN card is installed to be connected to a wireless Internet sharing router 410 in a house. An internet protocol (IP) address is assigned to the robot 430 by the wireless Internet sharing router 410 using a dynamic host configuration protocol (DHCP), so that the robot 430 is connected to the network. The robot 430 to which the IP address is assigned transmits a broadcast message to a subnet 400 network, which is constructed by the wireless Internet sharing router 410, to search for a robot control server 420. The robot control server 420 which is installed in a personal computer (PC) or the like in the house is connected to the internet sharing router 410 to which the robot 430 is connected. The robot control server 420 transmits its IP address to the robot 430 when it receives the broadcast message from the robot 430. Once the robot 430 has found the IP address of the robot control server 420 it periodically transmits messages to the robot control server 420 to request operational packets used for operating the robot 430. Then, the robot 430 downloads the operational packets and performs operations indicated by the robot control server 420. Here, even if the robot control server 420 communicates with the robot 430 using an unreliable user datagram protocol (UDP), since the robot control server 420 is connected to the internet sharing router 410 to which the robot 430 is connected, and is thus on the same subnet, packet delivery delay or packet loss due to another end-to-end hop does not occur.

A robot control middleware (423) which is executed in the robot control server 420 dynamically loads application components 421, which provide services to the robot 430, into a memory of the server, let the application components execute, and removes the application components 421 from the memory when the application components are not needed any more. In addition, the robot control middleware 423 transfers the operational packets to the robot 430 and receives a packet including sensor data from the robot 430. The robot control middleware 423 interprets the received packet, generates an appropriate event based on the interpreted information, and calls a method of the application component 421 based on the event to execute the application component 421. The called methods of the application components 421 generate a series of packets, which are to be sent to the robot 430, and transfer the generated packets to the robot control middleware 423. The robot control middleware 423 transfers the packets to the robot 430.

The application component 421 is a result from succeeding a standard interface called IRobotApplication 710 as illustrated in FIG. 7 and implementing methods defined in the standard interface 720, so that the application component 421 can be loaded and executed in the robot control middleware 423. The methods of the application component 421 implementing the IRobotApplication 710 are called when a corresponding event is generated by the robot control middleware 423.

Referring to FIG. 5, a robot control middleware 530 receives a request packet through a packet transfer unit 531 from the robot via a second connection unit 520 and a wireless internet sharing router. In addition, the robot control middleware 530 connects to an application component server 440 or a content server 450 through a first connection unit 510 via a communication network including the Internet. When an application component 421 received from the application component storage server 440 through the first connection unit 510 is adequate for storing, the application component is stored in a local application component storage 425 in operation S610. The request packet which is sent by the robot includes a serial number of an operational packet to be received by the robot, sensor and button data at a time when the request packet is sent from the robot, and microphone data which is collected for a predetermined time after a previous packet is sent. A packet interpretation unit 533 of the robot control middleware 520 extracts raw data of the sensor and button data from the request packet, interprets the raw data, and processes the raw data into meaningful data to generate an event. The event which is generated by the packet interpretation unit 533 is transferred to an event handling unit 535. When voice data is included in the request packet, the voice data is transferred to an automatic speech recognition (ASR) unit 538, so that the speech can be recognized. When the ASR unit 538 successfully recognizes speech using the voice data continuously received, the ASR unit 538 generates a string corresponding to a result of the speech recognition and transfers the generated string to an event handling unit 535. The event handling unit 535, which has received an event from the packet interpretation unit 533 or the ASR unit 538, calls a method of an application component 421 based on the type of the event. The methods of the application component 421 called by the event handling unit 535 generate an appropriate series of operational packets based on an internal status of the components and inserts the operational packets into an operational packet buffer of the robot control middleware through an addMotionPacket( ) method of the robot control middleware. When the methods of the application components do not generate operational packets inside the components and need to receive a continuous packet stream from an external content server 450, a getStreamPacket( ) method of the robot control middleware is called using an address of the content server 450, a content name, and an additional parameter and is immediately returned. The robot control middleware to which the getStreamPacket( ) method is called connects to a content server 450 using the address of the content server 450 which is received as a parameter through the application component unit 537, receives the requested contents in a stream of operational packets, and loads the stream into a packet buffer unit 539. The packet transfer unit 531 of the robot control middleware takes one packet from the packet buffer unit 539 and transfers the packet to the robot when the robot requests an operational packet in operation S630. In order to cancel operations to be performed and start a new operation based on an event value and an internal status of the component, packets that have been already stored in the packet buffer can be removed by calling clearPacketBuffer( ) of the robot control middleware.

In the procedures described above, operational packets which are generated by the application component are required to immediately respond to the sensor or button information or when a small operation which has been already defined. On the contrary, for an operational packet stream requiring contents to be downloaded from the content server, the robot plays the contents unilaterally without responding to the sensor or button information.

In the procedures described above, a hyper text transfer protocol (HTTP) may be used for the control server 420 to connect to the content server 440 and to acquire the operational packets. Accordingly, the form of the parameter which is used for the application component to call a getStreamPacket( ) of the middleware may be a stream of a uniform resource locator (URL) in operation S620.

In the robot control server 420 to which the robot is firstly connected, a basic application component 421 is executed on the robot control middleware 423. The basic application component 421 is implemented, so that a user of the robot can interact with the basic application component 421 through up, down, left, right buttons which are installed in the robot or speech recognition through a microphone to enable the user to select a desired service. When a specific button such as an escape button is pressed by the user while the robot performs a service, the application service which is currently performed may be stopped and the basic application component may operate to select another service.

When a desired service is determined by the interaction of the user with the basic application component, the middleware of the control server unloads the basic application component from the memory and searches for a corresponding application component in the local application component storage 425 for performing the service selected by the user. When a valid application component is found, the middleware of the control server loads the application component into the memory. On the other hand, when a corresponding application component is not found in the application component storage 425, the middleware of the control server searches for the application component in an application component storage server 440 which is connected to the Internet, downloads an application component code, and loads the application component code into the memory. The middleware of the control server generates a series of operational packets for speech output such as “the application is loading now, please wait for a moment.” and transfers the series of the operational packets to the robot so the robot can play them.

When the application component received from the application component storage server 440 has an attribute indicating that the application component can be stored in the local application component storage 425, the middleware of the control server stores the application component in the local application component storage 425 at the same time the application component is loaded in operation S610. Application components can be classified as having the following attributes based on whether they can be stored in the local application component storage 425.

1. Cacheable

The application component storage server 440 is requested to perform a validity test on the latest of the application components to check it. When the application components is the latest, the application component is loaded into the robot control middleware 530. Otherwise, a latest application component is downloaded again from the application component storage server 440.

2. Non Cacheable

The application component is not stored in the local application component storage 425. When the application component is required, the application component is downloaded from the application component storage server 440 and executed. When the execution is completed, the application component is discarded.

3. Permanent

When the application component is downloaded once, the code which is stored in the local application component storage 425 is immediately loaded and executed without the validity test.

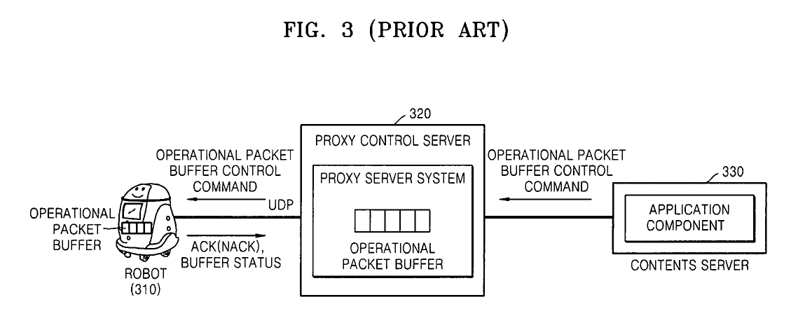

A push strategy in the related art and a pull strategy according to an embodiment of the present invention can be used for transferring a packet from the robot control server to the robot. In the push strategy illustrated in FIG. 3, the robot control server transfers a packet to the robot unilaterally with a period shorter than the operation period of a packet, the robot stores the packet downloaded from the server in the buffer, and the robot reads packets one by one to operate. On the other hand, in the pull strategy according to an embodiment of the present invention illustrated in FIG. 7, a packet is transferred to the robot 810 only when the robot 810 requests the next packet for the operation of the robot. The push strategy can be used adequately in order to prevent discontinuous operation of the robot, when delivery delay of a packet occurs due to instability of communication between the robot and the remote control server. However, since the packet downloaded from the control server to the robot is stored in the internal buffer of the robot, when the control server tries to transfer a new operation to the robot to cope with a change in the situation based on the sensor information, the robot should wait until all the operations corresponding to the operational packets stored in the internal buffer of the robot are completed or an additional mechanism for controlling the internal buffer of the robot is required. In an embodiment of the present invention, since the robot control server 820 is connected to the same subnet as the subnet to which the robot is connected, packet delivery delay or packet loss due to another end-to-end hop does not occur. Accordingly, in the present embodiment, the pull strategy in which a packet is transferred to the robot 810 for the operation of the robot only when the robot 810 requests a next packet is used. Here, operations of the application component 821, the robot control middleware 823, and the content server 830 are the same as described above, and a description of the operations are omitted.

The operation of the robot using the pull strategy according to an embodiment of the present invention will now be described with reference to FIG. 9. In a robot, a communication thread 910 which is responsible for communication with the robot control server and an operational thread 920 which is responsible for operations of the robot are included. The communication thread 910 and the operational thread 920 operate through one packet holder 930 in a producer-consumer pattern. In other words, when the communication thread 910 inside the robot requests the robot control server for a packet for a next operation in operation 911, the robot control server transfers the operational packet for the next operation to the robot. When the operational packet arrives in operation 913, the communication thread 910 inside the robot waits until the packet holder 930 becomes vacant in operation 915. When the packet holder 930 is vacant, the communication thread 910 stores the received operational packet in the packet holder 930 and requests a next operational packet immediately in operation 917. The operational thread 920, which is separated from the communication thread 910, reads the operational packet at a predetermined period in operation 921 and decodes the operational packet in operation 923. It uses the decoded operational packet to operate the robot through a motor, a speaker, an LCD, or the like for a predetermined time in operations 925 to 929. A maximum of three operational packets can be processed simultaneously inside the robot. In other words, an operational packet processed by the operational thread 920, an operational packet stored in the packet holder 930, and an operation packet which is newly transferred to the communication thread 910 from the robot control server are processed simultaneously. Since the communication thread 910 and the operational thread 920 are separated from each other, the robot can continue to operate while receiving a packet for a next operation, so that only the latest packet can be performed with a minimal buffer size without incurring discontinuity of the operation of the robot.

Various devices and methods of controlling network-based robots according to embodiments of the present invention will now be described briefly. When a device and method for controlling a network-based robot according to an embodiment of the present invention are applied to a low-priced robot which operates by periodically downloading an operational packet including operational information lasting a short time, a server system is configured using a robot control server connected to the same subnet to which the robot is connected for controlling the robot by sending an operational packet to the robot and receiving sensor information from the robot and a remote robot content server which provides information to be played by the robot to the control server in a stream. The robot control server includes a robot control middleware loading dynamically into the robot an application component which performs a service, executing the application component, and controlling a life cycle of the application component. When the robot is required to interact with the user immediately or respond to a surrounding environment in real time, an application component loaded in the control server connected to the same subnet to which the robot is connected generates an operational packet through the robot control middleware and sends the operational packet to the robot. On the other hand, when the interaction and real timeliness are not required, the robot control server transfers operational packets sequentially to the robot while downloading a series of the operational packets in a stream form from the content server. In transferring an operational packet from the robot control server to the robot, an operational packet is downloaded only when the robot requests the operational packet instead of transferring the operational packet to the robot unilaterally so that the operation of the robot can be processed in response to the surrounding environment in real time without-an additional buffer for storing downloaded operational packets inside the robot.

In a sever system controlling a low-priced robot which operates by continuously downloading operational packets including operational information which describes information about operation that lasts only for a short time from a robot control server through a network, a robot control server connected to the same subnet to which the robot is connected for controlling the robot by sending an operational packet to the robot and receiving sensor information from the robot and a robot content server for providing information to be played by the robot to the control server in a stream form from a remote place, and an application component storage server for storing codes for application components which are to be performed by the robot are included. The robot control server includes a robot control middleware which dynamically loads into the robot an application component which performs a service, let the application component execute, and controls a life cycle of the application component.

In a sever system according to another embodiment of the present invention for controlling a low-priced robot which operates by continuously downloading an operational packet including operational information which describes information about operation that lasts only for a short time from a robot control server through a network, a robot control server connected to the same subnet to which the robot is connected for controlling the robot by sending an operational packet to the robot and receiving sensor information from the robot and a content server for providing information to be played by the robot to the control server in a stream form from a remote place are included. In the server system, when the robot is required to interact with the user immediately or response to neighbor environments in real time, an application component loaded in a control server connected to the same subnet to which the robot is connected generates an operational packet through the robot control middleware and sends the operational packet to the robot. On the other hand, in a case of simple playback where the interaction and real timeliness are not required for the robot, the robot control server downloads a series of operational packets in a stream form from the content server and transfers the operational packets sequentially to the robot.

In a sever system according to another embodiment of the present invention for controlling a low-priced robot which operates by continuously downloading an operational packet including operational information which describes information about operation that lasts only for a short time from a robot control server through a network, a robot control server connected to the same subnet to which the robot is connected for controlling the robot by sending an operational packet to the robot and receiving sensor information from the robot and a content server for providing information to be played by the robot to the control server in a stream form from a remote place are included. In transferring an operational packet from the robot control server to the robot, an operational packet is downloaded only when the robot request for the operational packet instead of transferring the operational packet to the robot unilaterally, and accordingly, an additional buffer for storing downloaded operational packets is not provided inside the robot.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, an apparatus and method of controlling a network-based robot according to an embodiment of the present invention provides a quick response to the sensor information from the robot without laying a burden of connecting to various service servers and managing the connections on the robot. In addition, a size of an internal buffer of the robot is minimized to enable the robot to respond to neighbor environments in real time.

In addition, in controlling a low-priced robot which operates by periodically downloading an operational packet from a robot control server through a network, the robot control server is configured as the same subnet as that of the robot to solve a problem in that the operation of the robot is not performed smoothly and is paused intermittently according to delivery delay and non-uniform arrival time of the operational packets due to instability of communication between the robot and the remote control server without laying a burden of connecting to various service servers on the robot and to provide quick responsiveness to the sensor information from the robot. In addition, the size of the internal buffer of the robot is minimized to enable the robot to respond to neighbor environments in real time.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for controlling a network-based robot, the apparatus comprising:
a first connection unit connecting to at least one application component server or content server through a network;
a second connection unit connecting to a wireless internet sharing router to communicate with the robot; and
middleware receiving and storing an application component from the application component server, executing the application component to generate an operational command for the robot, sending the generated operational command to the robot, and processing information which is sent by the robot.

2. The apparatus of claim 1, wherein the middleware comprises:
a packet transfer unit sending an operational packet for the robot and receiving a request packet from the robot;
a packet interpretation unit generating an event based on the request packet;
an event handling unit calling a method of the application component based on a type of the event;
an application component unit generating the operational packet using the method of the application component or receiving a continuous stream from an external server and processing the stream into the operational packet; and
an operational packet buffer unit storing the operational packet and outputting the stored operational packet when the packet transfer unit requests the operational packet.

3. The apparatus of claim 2, wherein the packet interpretation unit further comprises a speech recognition unit performing speech recognition on voice data, converting the voice data into a string, and transferring the string to the event handling unit.

4. The apparatus of claim 2, wherein the request packet comprises:
a serial number of the operational packet to be received by the robot;
raw data generated by sensors and operations of buttons when the request packet is sent; and
data collected by the robot.

5. The apparatus of claim 1, further comprising a local application component storage unit classifying the application component which is received from the application component server into a cacheable attribute for which the application component is stored only when the application component is the newest, a non-cacheable attribute for which the application component is downloaded and executed as needed and discarded after execution, and a permanent attribute for which the application component is stored and executed without a validity test.

6. A method of controlling a network-based robot using a robot control server which controls the robot by connecting to at least one robot, application storage server, or content server, the method comprising:
(a) requesting an application component needed by the robot to the application storage server and receiving and storing the application component;
(b) generating events for each type based on sensor information which is transferred from the robot and generating an operational packet including information on an operation of the robot according to the type of the event; and
(c) sending the operational packet to the robot in response to the request of the robot.

7. The method of claim 6, wherein (b) comprises:
(b1) receiving a request packet from the robot;
(b2) generating the event based on the request packet;
(b3) calling a method of the application component based on the type of the event; and
(b4) generating and storing the operational packet by generating a first operational packet including the operational information on the robot based on the called method or receiving a continuous stream from an external server and processing the continuous stream into a second operational packet.

8. The method of claim 7, wherein (b4) comprises generating the first operational packet when it is determined that an immediate response is required based on a result of analyzing the request packet sent by the robot including the sensor information and generating the second operational packet when a one-side direction is sent to the robot.

9. The method of claim 6, wherein (a) further comprises classifying the application component which is received from the application component server into a cacheable attribute for which the application component is stored only when the application component is the newest, a non-cacheable attribute for which the application component is downloaded and executed as needed and discarded after execution, and a permanent attribute for which the application component is stored and executed without a validity test and storing the application component.

10. A method of controlling a network-based robot, the method comprising:
(a) preparing a communication thread which communicates with a robot control server, an operational thread which operates the robot, and a packet holder which connects the communication and operational threads;
(b) storing an operational packet and sending a request packet for a next operation to the robot control server when the packet holder is vacant;
(c) requesting an application component to an application storage server, and receiving and storing the application component by the robot control server that receives the request packet;
(d) generating events for each type based on sensor information which is transmitted by the robot and generating an operational packet including operational information on the robot for each type of the event;
(e) sending the operational packet to the robot in response to the request of the robot; and
(f) receiving the operational packet, checking whether the packet holder is vacant, storing the received operational packet when the packet holder is vacant, and waiting until the packet holder becomes vacant when the packet holder is not vacant.

11. The method of claim 10, wherein (e) comprises:
(e1) requesting the operational packet to the robot control server by the communication thread when the packet holder is vacant; and
(e2) operating the robot by periodically checking the packet holder using the operational thread and reading a packet stored in the packet holder.

12. A computer-readable medium having embodied thereon a computer program for a method of controlling a network-based robot using a robot control server which controls the robot by connecting to at least one robot, application storage server, or content server, the method comprising:
(a) requesting an application component needed by the robot to the application storage server and receiving and storing the application component;
(b) generating events for each type based on sensor information which is transferred from the robot and generating an operational packet including information on an operation of the robot according to the type of the event; and
(c) sending the operational packet to the robot in response to the request of the robot.

13. A computer-readable medium having embodied thereon a computer program for a method of controlling a network-based robot, the method comprising:
(a) preparing a communication thread which communicates with a robot control server, an operational thread which operates the robot, and a packet holder which connects the communication and operational threads;
(b) storing an operational packet and sending a request packet for a next operation to the robot control server when the packet holder is vacant;
(c) requesting an application component to an application storage server, and receiving and storing the application component by the robot control server that receives the request packet;
(d) generating a type of an event based on sensor information which is transmitted by the robot and generating an operational packet including operational information on the robot based on the type of the event;
(e) sending the operational packet to the robot in response to the request of the robot; and
(f) receiving the operational packet, checking whether the packet holder is vacant, storing the received operational packet when the packet holder is vacant, and waiting until the packet holder becomes vacant when the packet holder is not vacant.
